(19) United States
(12) Patent Application Publication
(10) Pub. No.: US 2008/0212457 A1
(43) Pub. Date: Sep. 4, 2008

(54) Scanning Of Multi-Layer Optical Record Carriers

(75) Inventors: Dominique Maria Bruls, Eindhoven (NL); Alexander Marc Van der Lee, Eindhoven (NL); Coen Andrianus Verschuren, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/994,538

(22) PCT Filed: Jul. 6, 2006
(86) PCT No.: PCT/IB2006/052283

§ 371 Date: Jan. 3, 2008

(30) Foreign Application Priority Data
Jul. 7, 2005 (EP) 05300568.2

(51) Int. Cl. G11B 7/00

(52) U.S. Cl. 369/275.1

(57) ABSTRACT

An optical scanning device for scanning a first and a second information layer of an optical record carrier, a scanning method, and an optical record carrier. The device includes at least one radiation source for providing a first radiation beam for scanning the first information layer and a second radiation beam for scanning the second information layer. An objective lens system is arranged to converge the first and second radiation beams on the respective information layers. The device is configured to determine tracking information from only one of said radiation beams, for tracking error compensation.

The present invention relates to apparatus and methods for scanning multi-layer optical record carriers, to multi-layer optical record carriers, and to methods of manufacture of suitable apparatus and suitable optical record carriers.

Optical record carriers exist in a variety of different formats, with each format generally being designed to be scanned by a radiation beam of a particular wavelength. For example, CDs (compact discs) are available, inter alia, as CD-A (CD-audio), CD-ROM (CD-read only memory) and CD-R (CD-recordable), and are designed to be scanned by means of a radiation beam having a wavelength (λ) of around 785 nm. DVDs (digital versatile discs), on the other hand, are designed to be scanned by means of a radiation beam having a wavelength of about 650 nm, and BDs (Blu-ray discs) are designed to be scanned by means of a radiation beam having a wavelength of about 405 nm. Generally, the shorter the wavelength, the greater the corresponding capacity of the optical disc e.g. a BD-format disc has a greater storage capacity than a DVD-format disc.

Information is stored on the disc by an information layer. In order to further increase the storage capacity of optical discs, multi-layer optical discs have been proposed. Multi-layer optical discs contain two or more discrete information layers.

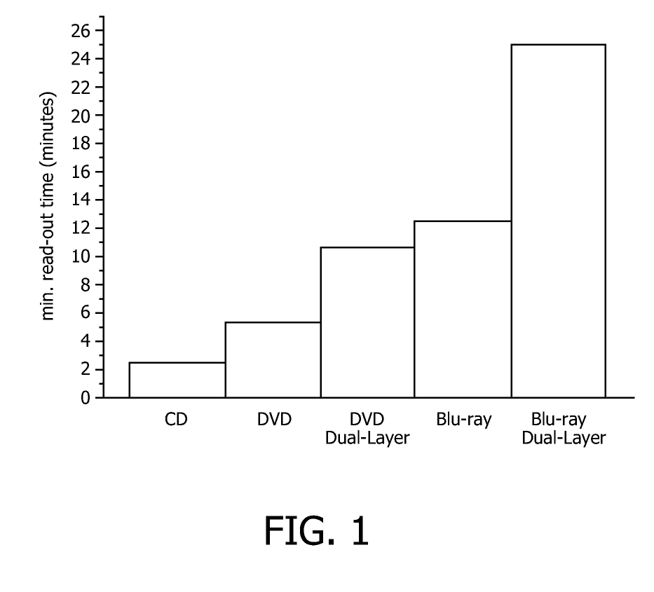

It is desirable that the time required for reading data from/writing data to an entire optical disc is as short as possible. However, for each generation of optical storage, the capacity of the disc increases by a greater amount than the maximum read/write data-rate. For example, FIG. 1 is a graph illustrating the typical minimum time required to read out different types of optical disc. The term “dual layer” refers to a multi-layer optical disc having two information layers. It will be observed that the time needed for reading/writing an entire optical disc increases, as the storage capacity of the disc increases.

In optical discs, the maximum readout/recording speed is limited by the maximum (safe and/or stable) rotation speed of the disc. In order to obtain higher readout speeds, it has been proposed that complete multiple optical pickup units (OPUs) are incorporated within a single apparatus, with each OPU utilised to read from/write to a different information layer. However, incorporating two or more OPUs within a single apparatus leads to a corresponding increase in both size and cost of the apparatus.

U.S. Pat. No. 6,600,704 describes an apparatus for simultaneously reading from or writing to two different information carrier layers of an optical recording medium. U.S. Pat. No. 6,600,704 describes using a largely common optical path for the different partial beams, with each partial beam being focussed on a different information carrier layer.

It is an aim of the embodiments of the present invention to address one or more problems of the prior art, whether described herein, or otherwise. It is an aim of particular embodiments of the present invention to provide an optical scanning device suitable for scanning multi-layer optical record carriers, that is relatively cheap and easy to manufacture.

According to a first aspect of the present invention, there is provided an optical scanning device for scanning a first and a second information layer of an optical record carrier, the device comprising: at least one radiation source for providing a first radiation beam for scanning the first information layer and a second radiation beam for scanning the second information layer; an objective lens system for converging the first and second radiation beams on the respective information layers; wherein the device is configured to determine tracking information from only one of said radiation beams, for tracking error compensation.

By requiring the apparatus to only determine the tracking information for a single information layer, the optical scanning device is simplified, and can thus be made in an easier way and more cheaply. Tracking compensation can be applied to all scanning radiation beams simultaneously, thus avoiding the additional cost of providing multiple actuators for providing tracking compensation for each separate scanning radiation beam.

The device may further comprise an actuator system for providing tracking error compensation for both the first and the second radiation beams, the actuator system being arranged to only utilise said tracking information from only one radiation beam.

The objective lens system may be configured to focus said first radiation beam and said second radiation beam at different axial positions along a common optical axis.

The objective lens system may be arranged to focus the first radiation beam at a position along a first optical axis, and the second radiation beam at a position along a second, different optical axis.

The optical record carrier may be an optical disc, with the second optical axis tangentially offset from the first optical axis.

The objective lens system may be arranged to converge the second radiation beam at a position a predetermined, fixed lateral distance from that of the first radiation beam.

The first radiation beam may comprise a first wavelength, and the second radiation beam comprises a second, different wavelength.

The device may further comprise a non-periodic phase structure for converging both of said radiation beams on a common information detector.

The first and said second radiation beams may be modulated, for allowing information from both information layers to be detected by a common information detector.

The device may be arranged for scanning a third information layer of the optical record carrier; the at least one radiation source may be arranged to provide a third radiation beam for scanning the third information layer; and the objective lens system may be arranged to converge the third radiation beam on the third information layer.

The device may be configured to determine focus information from only one of said radiation beams, for focus error compensation.

According to a second aspect of the present invention, there is provided a method of manufacturing an optical scanning device for scanning a first and a second information layer of an optical record carrier, the method comprising: providing at least one radiation source for providing a first radiation beam for scanning the first information layer and a second radiation beam for scanning the second information layer; providing an objective lens system for converging the first and second radiation beams on the respective information layers; and configuring the device to determine tracking information from only one of said radiation beams, for tracking error compensation.

According to a third aspect of the present invention, there is provided a method of scanning a first information layer and a second information layer of an optical record carrier, the method comprising: converging a first radiation beam on the first information layer; converging a second radiation beam on a second information layer; and controlling the tracking of the radiation beams on the information layers, based upon a tracking information signal, wherein the tracking information signal is determined from only one of said beams, but utilised to provide tracking error compensation for both said first and said second radiation beams.

The first radiation beam may write information to the first information layer, and the second radiation beam writes information to the second information layer.

The method may further comprise detecting at least a portion of the first radiation beam reflected from the first information layer and at least a portion of the second radiation beam reflected from the second information layer, for determining information on said layers.

The method may further comprise detecting the lateral distance between information stored on the first information layer and information stored on the second information, and configuring the second radiation beam to scan the second information layer at the determined fixed lateral distance from the first radiation beam.

According to a fourth aspect of the present invention, there is provided an optical record carrier comprising: a first information layer; a second information layer, wherein only one of said layers is arranged to provide tracking information to an incident scanning radiation beam.

Only one of said layers may comprise a grooved structure.

Alternatively, only one of said layers may comprise a ROM layer.

According to a fifth aspect of the present invention, there is provided a method of manufacturing an optical record carrier, the method comprising: forming a first information layer; forming a second information layer, wherein only one of said first and said second information layers is arranged to provide tracking information.

Embodiments of the invention will now be described, by way of example only, with reference to the accompanying drawings, in which:

FIG. 1 is a chart indicating the different times required to read out different formats of optical disc of the prior art;

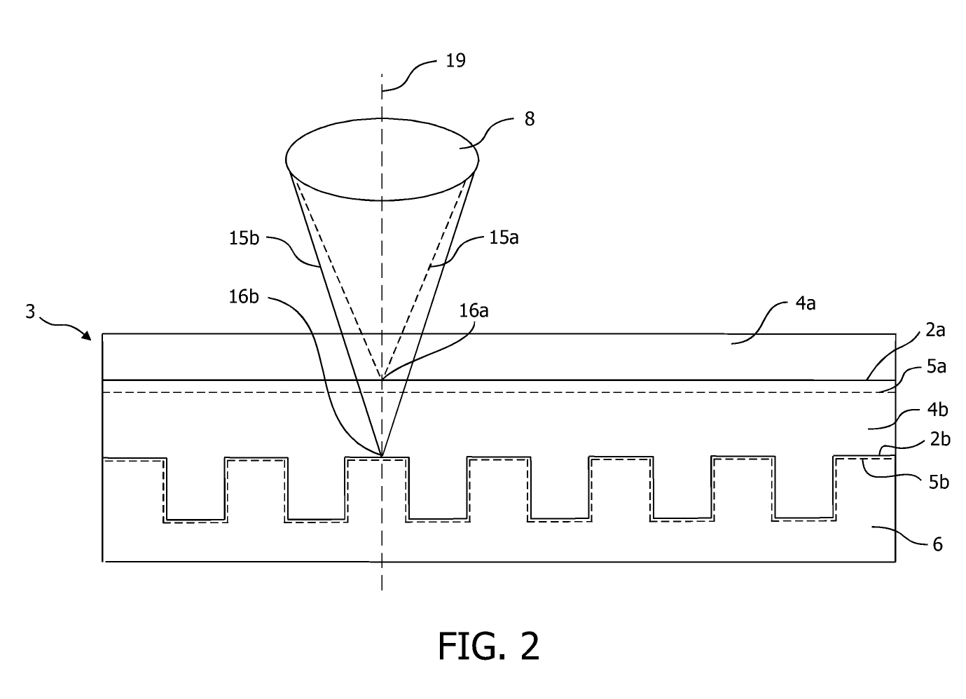

FIG. 2 is a schematic cross-sectional side view of a dual layer optical record carrier being scanned by two radiation beams, in accordance with an embodiment of the present invention;

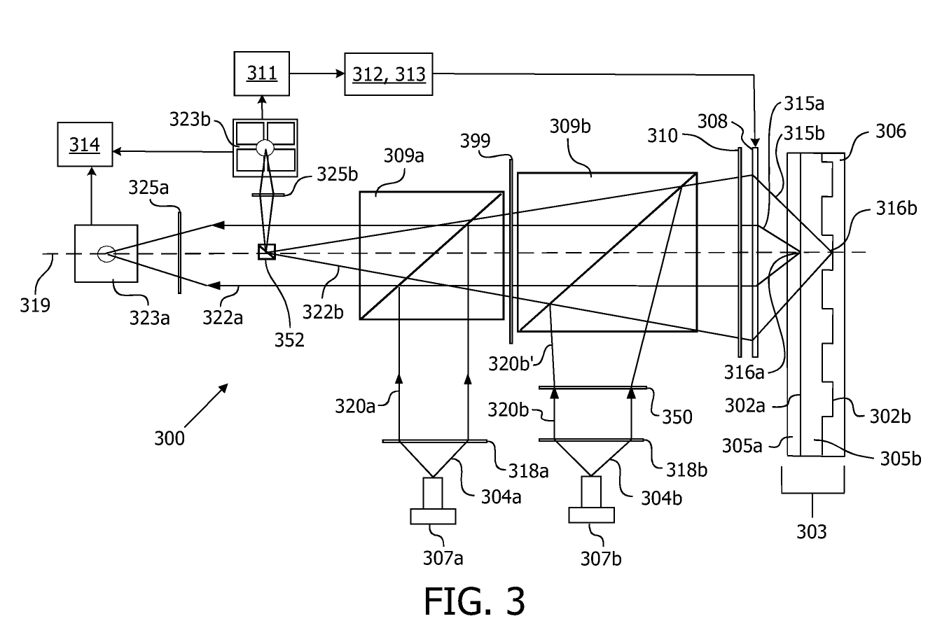

FIG. 3 is a schematic diagram of an optical scanning device in accordance with an embodiment of the present invention;

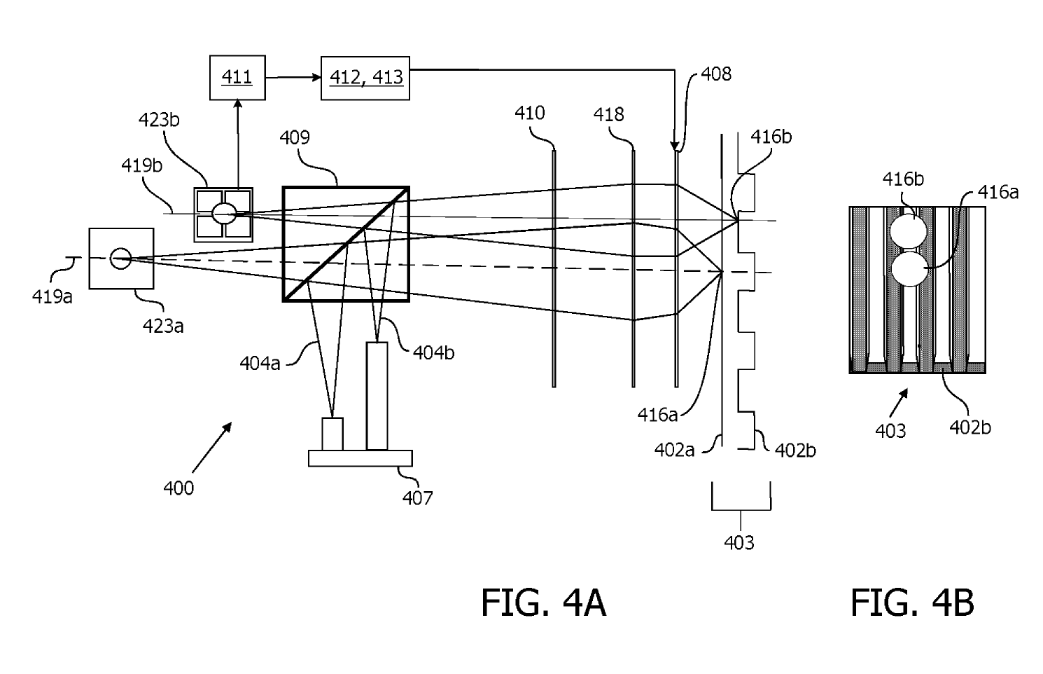

FIG. 4A is a schematic diagram of an optical scanning device in accordance with another embodiment of the present invention;

FIG. 4B is a plan view of the optical record carrier being scanned by the device illustrated in FIG. 4A; and

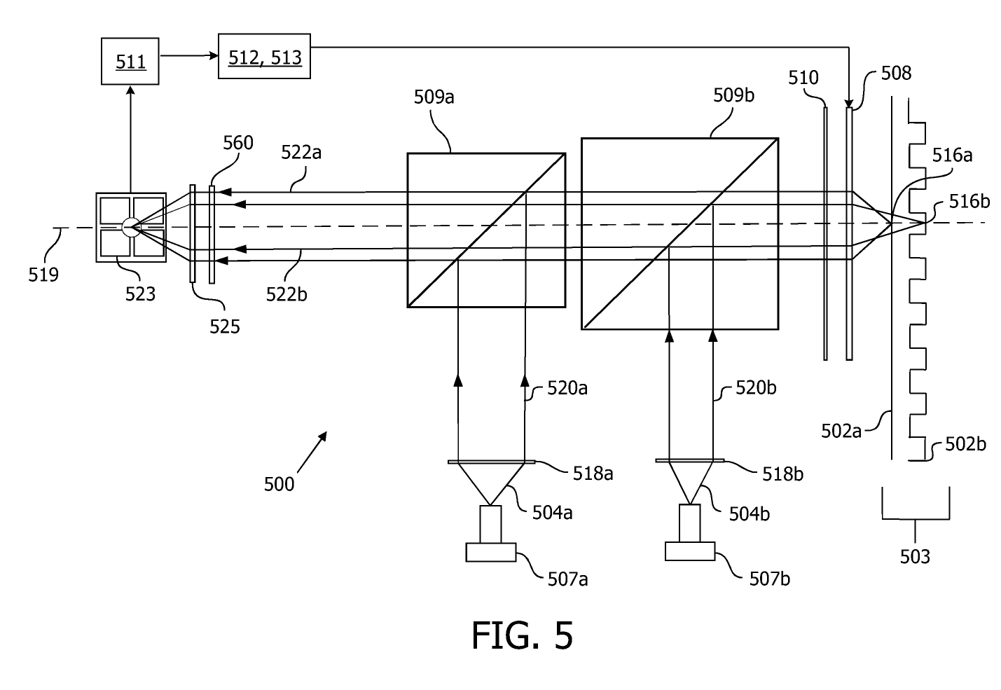

FIG. 5 is a schematic diagram of an optical scanning device in accordance with a further embodiment of the present invention.

The present inventors have realised that multi-layer optical record carriers can be cheaply and effectively scanned, by using a separate radiation beam for scanning each layer, with tracking information from only one of the radiation beams being utilised to control the tracking of all of the beams. Tracking information from only one of the radiation beams incident upon one of the layers is determined, for tracking error compensation. The resulting tracking information is then utilised to control the tracking of all of the scanning radiation beams. The radiation beams can thus be regarded as being operated in a master-slave configuration. Multiple information layers can be read-out or written to simultaneously. This is in contrast to conventional double-layer discs, in which only one layer at a time is read from or written to.

Information can be recorded on an optical record carrier in accordance with a preferred embodiment, with only one of the information layers containing tracking information. Information is written to the other layer(s) in a position having a predetermined relationship relative to information on the layer containing the tracking information e.g. with information tracks on each layer written exactly on top of each other, or with a predetermined tangential or lateral offset. During readout, the tracking of each of the radiation beams is controlled utilising a single tracking information signal derived from the information layer containing the tracking information, thus enabling the readout of the multiple layers simultaneously, due to the tracks in the different information layers having a fixed, predetermined relationship relative to each other during the recording process.

Such an optical record carrier is in contrast to conventional dual-layered DVDs. In such conventional DVDs, both information layers have a groove structure. Due to the manufacturing process, the tracks of the first information layer of the dual layer DVD are not aligned with the tracks of the second information layer. As the data-tracks are not aligned, the different information layers may have different eccentricity, with the tracking information derived from one layer requiring different tracking error compensation than the tracking information derived from the other layer. For example, U.S. Pat. No. 6,600,704 describes how different information carrier layers of an optical record carrier can be scanned, each by a different partial beam. Although the partial beams share a largely common optical path, individual “beam influencing means” are provided for each partial beam, to ensure that each partial beam correctly tracks a respective information layer.

The present inventors have realised that, by utilising tracking information from only a single information layer, as described herein, optical scanning devices can be created that are cheaper and smaller. Such optical scanning devices do not require detection and calculation of tracking information for each individual information layer. Further, such optical scanning devices do not require the provision of separate actuators for controlling the tracking of the radiation beams utilised to scan different information layers. Also, disc manufacturing can be more cost efficient, as only one replication step is needed.

FIG. 2 is a schematic cross-sectional diagram illustrating the scanning of optical record carrier 3 comprising two separate information layers 2a, 2b. The information layers are scanned by converting a first radiation beam 15a to a first spot 16a on the first information layer 2a, and by converting a second radiation beam 15b to a second spot 16b upon the second layer information 2b.

The information layers 2a, 2b generally extend in substantially parallel planes. The term lateral refers to a distance within the planes. The terms height or depth refer to a distance perpendicular to the planes. The radiation beams 15a, 15b are converged on the respective information layer 2a, 2b via objective lens 8. The objective lens 8 has an optical axis 19.

The transparent cover layer 4a overlies first information layer 2a. Transparent spacer layer 4b separates, and provides a predetermined spacing (height) between, the information layers 2a, 2b. The layers are formed on a substrate 6. A reflective layer 5a, 5b extends parallel to and underlies each information layer 2a, 2b. The upper reflective layer 5a (adjacent the source of radiation beams 15a, 15b) is semi-transparent i.e. only partially reflective. The lower reflective layer 5b (distant from the source of the radiation beams 15a, 15b) is fully reflective. Hence, it is possible to focus on each recording layer, and detect the reflected signals from each layer.

Only one of the information layers 2a, 2b has a groove structure. In the embodiment shown in FIG. 2, the groove structure of the second layer 2b is illustrated as a series of steps. The groove structure of information layer 2b is used to provide tracking information and focus information during the recording (and the reading) of information on both information layers. Thus, tracking information, and focus information is determined from only one of the radiation beams (radiation beam 15b in this embodiment). A tracking error signal is derived from the tracking information. A focus error signal is derived from the focus information. All (both) of the radiation beams are controlled utilising the same tracking and focus error information, such that the tracks in the different layers are written on top of each other, in a predetermined alignment. Thus, radiation beam 15b provides the tracking and focus information (and acts as the “master” beam), with the other radiation beam 15a being controlled utilising the same tracking and focus information (i.e. acting as a “slave” radiation beam). In this particular beam, radiation spots 16a, 16b are aligned along a single common optical axis 19. Thus, the tracks in the different layers 2a, 2b are aligned along an axis perpendicular to the planes of layers 2a, 2b.

During the manufacturing of the optical record carrier 3, it will be appreciated that information layers 2a, 2b need not be aligned on top of each other, as only one grooved layer is required. This grooved layer 2b ensures alignment of all tracks in all of the other information layers. Further, the multi-layer disc can be recorded at a relatively high speed as information is recorded on all of the information layers at the same time.

In this particular embodiment, the optical record carrier 3 is an optical disc. Once the disc has been written to, the disc has an information layer 2b that is a conventional +R(W) layer and an information layer 2a formatted as a quasi ROM layer. Such a quasi ROM layer has no groove, but only a data track from which the bits can be detected due to the difference in reflection coefficient between the bit-areas and non-bit areas. In multi-layer optical record carriers incorporating three or more information layers in accordance with another embodiment, only a single conventional +R(W) layer is provided, with the remainder of the layers having the same character as a ROM layer.

During readout, each of the layers can be read simultaneously, as the disc structure ensures alignment of the recorded tracks of the different information layers. Tracking and focus information are preferably provided by the radiation beam 15b converged on the grooved information layer 2b, with the other radiation beam 15a reading from information layer 2a, and slaved to radiation beam 15b. Alternatively, a single radiation beam system (e.g. a conventional DVD, BD system) can be utilised to individually read out the different layers of the recorded disc. Thus, although the disc is non-typical, it can be utilised in conventional systems.

It will be appreciated that the above embodiment is provided by way of example only, and that various alternatives may be apparent to the skilled person based upon the teachings herein. For instance, in the above embodiment, focus information is described as being determined from information layer 2b. However focus information can be determined from either of the information layers 2a, 2b, or both information layers 2a, 2b. The detector utilised to detect the radiation beam for determining focus information is a split-detector (i.e. a detector comprising two or more different detection portions). However, only the grooved information layer 2b is utilised for providing tracking control during the writing of information to the information layer 5.

In the above embodiment, tracking information is embedded within a single information layer, by that information layer 2b having a grooved structure. Continuous grooves are simply one technique for providing tracking information on optical media. A typical groove is a fraction of a micron wide, and approximately ⅛ of a wavelength deep (relative to the wavelength of scanning radiation). Tracking information can be determined by measuring the symmetry of the reflected beam. For instance, the focused spot 16b moves away from the centre of the track, an asymmetry develops in the intensity pattern at the detector. Measuring an indication of the asymmetry (e.g. using a split detector) allows the determination of a tracking information, and hence the generation of a tracking error signal.

It will be appreciated that other techniques can be utilised to provide tracking information within a single information layer, other than grooves.

For instance, a set of discrete pairs of marks may be placed on the information layer at regular intervals (the so-called sampled servo scheme). As such marks are slightly offset from the track centre in opposite directions, the reflected light first indicates the arrival of one and then the other of these wobble marks. Depending on the position of the spot on the track, one of these pulses of reflected light may be stronger than the other, this tracking information indicating the direction of tracking error.

Alternatively, the radiation beam may be divided into three beams, one of which follows the track under consideration, while the other two are focused on adjacent tracks, immediately before and after the desired track. Any movement of the scanning spot away from the desired position on the central track causes an increase in the signal from one of the outrigger radiation beams, and simultaneously, a decrease in signal from the other outrigger. A comparison of the outrigger signals provides tracking information, and the generation of a tracking error signal.

In all cases, the resulting tracking information and/or tracking error signals are fed to a servo or actuator, for controlling tracking of the scanning radiation beams.

FIG. 3 shows a device 300 for scanning a first information layer 302a of an optical record carrier 303 by means of a first radiation beam 304a, and for scanning a second information layer 302b of the optical record carrier with a second radiation beam 304b. The device includes an objective lens system 308.

The optical record carrier is similar to the optical record carrier described with reference to FIG. 2. Similar features are identified with similar reference numerals, but with the reference numerals incremented by 300.

The optical record carrier 303 comprises an outer transparent layer 305a, on one side of which first information layer 302a is arranged. A second transparent layer 305b separates second information layer 302b from the first information layer 302a. The side of the information layer 302b facing away from the transparent layer 305b is protected from environmental influences by a protective layer 306. The side of the transparent layer 305a facing the device is called the entrance face. The transparent layers 305a, 305b can act as substrates for the optical record carrier 303 by providing mechanical support for the information layers 302a, 302b. Alternatively, a transparent layer 305a may have the sole function of protecting the outer information layer 302a, with the transparent layer 305b simply acting as a spacer between the information layers 302a, 302b. Mechanical support is then provided by a layer on either side of the information layer 302b, for instance by the protective layer 306. Firstly information layer 302a has a first information depth that corresponds, in the embodiment shown in FIG. 3, to the thickness of the first transparent layer 305a. Second information layer 302b has second information depth that corresponds to the thickness of transparent layers 305a, 305b and information layer 302a. The information layers 302a, 302b are surfaces of the carrier 303.

Information is stored on the information layers 302a, 302b of the record carrier 303 in the form of optically detectable marks arranged in substantially parallel, concentric or spiral tracks. A track is a path that may be followed by the spot of a focused radiation beam. The marks may be in any optically readable form, e.g. in the form of pits, or areas with a reflection coefficient, e.g. direction of magnetisation different from the surroundings, or a combination of these forms. In this particular embodiment, the optical record carrier 303 is formed in the shape of a disc. Only one of the information layers contains information suitable for utilising for controlling the tracking of a radiation beam upon the layer i.e. tracking information. The tracking information is provided by second information layer 302b as a series of grooves (indicated as a stepped profile of information layer 302b within the figure).

As shown in FIG. 3, the optical scanning device 300 includes radiation source 307a, 307b, collimator lenses 318a, 318b, beam splitters 309a, 309b, an objective lens system 308 having an optical axis 319, and a detection system 323a, 323b. Furthermore, the optical scanning device 300 includes a servo circuit 311, a focus actuator 312, a radial actuator 313, and an information-processing unit 314.

The radiation source 307a, 307b is arranged for supplying a first radiation beam 304a and a second radiation beam 304b. In this particular embodiment, the radiation source comprises two discrete radiation sources 307a, 307b. The first radiation source 307a is arranged to provide first radiation beam 304a, and the second radiation source 307b is arranged to supply the second radiation beam 304b. However, it will be appreciated that in other embodiments, two (or more) radiation beams may be generated from a single radiation source.

The first radiation beam 304a has a wavelength λ₁ and a polarisation p₁, and the second radiation beam 304b has a wavelength λ₂ and a polarisation p₂. The radiation beams may have the same wavelength (i.e. λ₁=λ₂), or the wavelengths may be different. The radiation beams 304a, 304b may have the same polarisation, or the polarisations p₁, p₂ may differ from each other. In this particular embodiment, the radiation beams 304a, 304b have the same wavelength and polarisation.

Collimator lenses 318a, 318b are arranged in the optical path between the radiation sources 307a, 307b and the objective lens system 308, for transforming the divergent radiation beams 304a, 304b emitted from each radiation source into respective substantially collimated radiation beams 320a, 320b.

Beam splitters 309a, 309b are arranged for transmitting the radiation beams 320a, 320b along an optical path towards the objective lens system 308. In the example shown, each radiation beam 320a, 320b is transmitted towards the objective lens system 308 by reflection from a respective beam splitter 309a, 309b. Preferably, the beam splitters 309a, 309b are each formed with a plane parallel plate that is tilted at an angle a with respect to the optical axis, and more preferably α=45°.

The objective lens system 308 is arranged for transforming the collimated radiation beam 320a to a first focus radiation beam 315a so as to form a first scanning spot 316a in the position of the first information layer 302a. Similarly, the objective lens system 308 is arranged for transforming the radiation beam 320b to a second focused radiation beam 315b so as to form a second scanning spot 316b in the position of the second information layer 302b. The objective lens system 308 can be formed as a single lens, or as a compound lens.

The two focused radiation beams 315a, 315b have focal points (i.e. the spots 316a, 316b) at different positions along the optical axis 319. In this particular embodiment, the wavelengths of the first and second radiations are the same. In order to ensure that the spots 316a, 316b are at different positions along the optical axis 319, one of the radiation beams incident upon the objective lens system 308 has a different convergence (or divergence) than the other radiation beam.

In the embodiment illustrated in FIG. 3, the first radiation beam 320a is collimated when incident upon objective lens system 308. The second radiation beam 320b′ is divergent, when incident upon objective lens system 308. In this embodiment, the divergence of the second radiation beam is achieved by placing an additional lens 350 in the optical path behind the collimator lens 318b. This results in second radiation beam 320b′ having a different position of focus along the optical axis 319. Alternatively, instead of providing an additional lens 350 in the optical path of the radiation beam 320b, the divergence of the second radiation beam 320b′ could be achieved by altering the power of the collimator lens 318b or adjusting the position of the collimator lens 318b. Preferably, lens 350 or lens 318b is arranged to apply a predetermined aberration (e.g. spherical aberration) to incident radiation, so as to compensate for aberrations introduced by the difference in focus distance of the objective lens.

During scanning the record carrier 303 rotates on a spindle. First information layer 302a is then scanned through the transparent layer 305a. The first focused radiation beam 315a reflects on the first information layer 302a, thereby forming a reflected beam, which returns on the optical path of the forward converging beam 315a. The objective lens system 308 transforms the reflected first radiation beam to a reflected collimated radiation beam 322a.

Similarly, the second information layer 302b is scanned through the transparent layers 305a, 305b. The second focused radiation beam 315b reflects on the second information layer 302b, thereby forming a reflected beam, which returns on the optical path of the forward converging second radiation beam 315b. The objective lens system 308 transforms the reflected second radiation beam to a reflected radiation beam 322b having the same convergence (or divergence) as beam 320b′.

The beam splitters 309a, 309b separate the forward radiation beams 320a, 320b′ from the reflected radiation beams 322a, 322b by transmitting at least part of the reflected radiation 322a, 322b along an optical path towards the detection system 323a, 323b. In the illustrated example, the reflected radiation beams 322a, 322b are transmitted towards the detection system 323a, 323b by transmission through a plate within each beam splitter 309a, 309b.

A half waveplate (λ/2 plate) 399 is located on the optical path between the beam splitters 309a, 309b. The half waveplate swaps the polarization state of incident radiation e.g. incident vertically polarized light changes to horizontally polarized light, on transmission through the waveplate. The waveplate 399 ensures that the radiation beams are in the correct polarization states for direction by the polarizing beam splitters along the appropriate optical paths.

A quarter waveplate 310 is positioned along the optical axis 319 between the beam splitters 309a, 309b and the objective lens system 308. The combination of the quarter waveplate 310 and the polarising beam splitters 309a, 309b ensures that the majority of the reflected radiation beams 322a, 322b are transmitted towards the detection system 323a, 323b along optical axis 319. Alternatively, non-polarising beam-splitters can be used (without the waveplates), but such beam splitters lack the throughput advantage of polarising beam-splitters.

In the embodiment illustrated in FIG. 3, each reflected radiation beam 322a, 322b is detected by a separate detector 323a, 323b. The two reflected radiation beams 322a, 322b are separated, for transmission towards the respective information detectors. In this particular embodiment, reflected second radiation beam 322b, which is convergent is focused on a mirror 352, to separate the two reflected radiation beams 322a, 322b. The mirror 352 is located on the optical axis 319. The mirror 352 only occupies a fraction of the beam waist of radiation beam 322a. The majority of the reflected first radiation beam 322a is transmitted without reflection along the optical path towards detector 323a. The reflected second radiation beam 322b is reflected by the mirror towards information detector 323b.

Convergent lens 325a is arranged to capture reflected radiation beam 322a, and converge the radiation beam on detector 323a. Similarly, convergent lens 325b is arranged to capture reflected radiation beam 322b, and converge the radiation beam on respective information detector 323b.

Each detector 323a, 323b is arranged to convert the incident respective reflected beam 322a, 322b to one or more electrical signals. The first detector 323a is arranged to convert incident reflected first radiation beam 322a to a first information signal. The value of the first information signal represents the information scanned on the first information layer 302a. Second radiation detector 323b is arranged to convert incident radiation beam 322b to a second information signal. The value of the second information signal represents the information scanned on the second information layer 302b. The information signals are processed by the information processing unit 314 for error correction.

Radial tracking information is derived from only one of the reflected beams, and utilised to control the tracking of all of the radiation beams upon the optical record carrier.

In this particular embodiment, second information layer 302b provides tracking information. Thus, the radiation detector 323b, used to detect the radiation beam 322b reflected from layer 302b, determines the tracking information, and hence the tracking error information for controlling the tracking of all of the radiation beams. Detector 323b determines a focus error signal and a radial tracking error signal. The focus error signal represents the axial difference in height along the Z-axis between the scanning spot 316b and the position of the information layer 302b. It is assumed that the layers of the optical record carrier 303 extend substantially in the XY plane. Preferably, this focus error signal is formed by the “astigmatic method” which is known from inter alia, the book by G. Brouwhuis, J. Braat, A. Huijser et al, “Principles of Optical Disc Systems”, (Adam Hilger 1985, ISBN 0-85274-785-3), in which case the relevant convergent lens (325b) is an astigmatic lens. The (radial) tracking error signal represents the distance in the XY-plane of the second information layer 302b between the scanning spot 316b and the centre of track in the second information layer 302b to be followed by the scanning spot 316b. This signal can be formed from the “radial push-pull method” which is also known from the aforesaid book by G. Brouwhuis.

In this particular embodiment, the information on first information layer 302a is aligned with the information on second information layer 302b along the Z-axis. Thus, the radial tracking error signal also represents the distance in the XY-plane of the information layer 305a between the first scanning spot 316a and the centre of track in the first information layer 302a to be followed by the first scanning spot 316a. The second information layer 302b is at predetermined depth beneath first information layer 302a. Hence, the focus error signal is also indicative of the axial difference in height along the Z-axis between the first scanning spot 316a and the position of the first information layer 302a.

The servo circuit 311 is arranged for, in response to the focus and radial tracking error signals, providing servo control signals for controlling the focus actuator 312 and the radial actuator 313, respectively. The focus actuator 312 controls the position of the objective lens 308 along the Z-axis, thereby controlling the position of the scanning spots 316a, 316b such that the spots coincide substantially with the respective plane of the respective information layers 302a, 302b. The radial actuator 313 controls the radial position of the scanning spots such that the spots coincide substantially with the centre line of the track to be followed in the respective information layer 302a, 302b, by altering the position of the objective lens 308. Thus, a single tracking information signal is used to control the objective lens 308, so as to ensure that each radiation spot is correctly tracked across the surface of the respective information layer being scanned by that spot.

Any one or more of the scanning spots 316a, 316b may be formed with two additional spots for use in providing an error signal. These associated additional spots can be formed by providing an appropriate diffractive element in the path of the optical beam(s).

Thus, the apparatus 300 uses a tracking error signal derived only from the tracking information on one information layer, to control the tracking of the plurality of radiation beams, each reading a different information layer. A single actuator is utilised to control the tracking position of all of the beams. Tracking information is not utilised by the apparatus 300 from any one of the other information layers. Further, only a single tracking actuator controls the tracking of all of the radiation beams i.e. no other actuators or devices are provided within the apparatus 300 for controlling the tracking of any of the beams individually. This single actuator can also be utilised to control the focus position of the radiation beams, i.e. actuators 312, 313 can be implemented by a single device.

The above embodiment in FIG. 3 is described by way of example only. FIGS. 4A and 5 show other optical scanning devices 400, 500. Within FIGS. 4A and 5, similar features to those illustrated in FIG. 3 are identified by similar reference numerals. Similar features perform similar functions. However, the features illustrated in FIG. 4A are prefixed with the number 400, and the features in FIG. 5 are prefixed with the number 500 (as opposed to the features in FIG. 3, which are prefixed with the number 300).

FIG. 4A shows an optical scanning device 400 in accordance with a further embodiment. In the embodiment shown in FIG. 3, the optical scanning device is arranged to focus each spot 316a, 316b at the same XY position on the disc. In the optical scanning device 400 illustrated in FIG. 4A, the radiation beams are focused at different lateral positions on the disc i.e. at different positions in the X-Y plane.

FIG. 4B shows a plan view of the relative positions of the spots 416a, 416b, as viewed along the optical axis 419a, 419b. It will be observed that the spots 416a, 416b are shifted in the tangential direction (along the track direction) with respect to each other. By providing such an offset, thermal interference between the two information layers 402a, 402b can be prevented. This is particularly significant when information is being recorded, due to the higher power radiation beams typically used to record information on information layers (as compared to the power of the radiation beams used to read information from information layers).

By shifting spot 416a relative to the other spot 416b in the tangential direction, the information can still be written on the information layer on tracks that extend on top of each other. Alignment between the tracks in the different information layers 402a, 402b is thus still maintained. Information can then be read from the written tracks, using a similar system with the same predetermined offset between the two radiation spots. However, also spots that are exactly aligned on top of each other can be used to read-out a disc that has been recorded in the before-mentioned manner.

In this particular embodiment 400, a single radiation source 407 is utilised to provide both the first radiation beam 404a and the second radiation beam 404b. For example, the radiation source 407 can be a dual-beam laser-diode. The emission points of the two lasers are slightly shifted relative to the optical axis of the laser unit 407. This causes a desired difference in lateral position of the focussed radiation beams 404a, 404b. The radiation source 407 (e.g. laser-diode) is oriented such that the radiation spots 416a, 416b formed by the radiation beams 404a, 404b are shifted in the tangential direction with respect to each other on the optical record carrier 403. As the radiation beams 404a, 404b are emitted at different distances from the beamsplitter 409, the focus points of the two radiation beams are shifted with respect to each other along the direction of the optical axes as well. Both beams 404a, 404b have the same wavelength and polarisation.

The diverging radiation beams from radiation source 407 are transmitted, via polarising beam splitter 409 towards objective lens system 408. Objective lens system 408 focuses each beam at a respective, different, lateral position on the respective information layer. Thus, the first radiation beam 404a is converged by the lens 408 on first information layer 426a to a spot 416a and second radiation beam 404b is converged to a spot 416b on second information layer 402b. Collimator lens 418 ensures that both the first and second radiation beams are collimated, prior to being incident on objective lens 408. A quarter waveplate 410 is placed in the optical path of both radiation beams, between the beam splitter 409 and the objective lens 408. The quarter waveplate 410 ensures that the radiation beams reflected from the respective information layers 402a, 402b are each transmitted by the beam splitter 409 to a respective information detector 423a, 423b, by altering the polarisation of the radiation beams.

As previously, only one of the radiation detectors 423b (in this example, a split-photodetector) is arranged to determine the tracking error signal based upon only one of the reflected radiation beams. A servo circuit 411 is arranged, in response to the calculated focus and radial tracking error signals, to provide servo control signals for controlling the focus actuator 412 and the radial actuator 413.

FIG. 5 shows an optical scanning device 500 in accordance with an alternative embodiment. First radiation source 507a is arranged to provide first radiation beam 504a and second radiation source 507b is arranged to provide second radiation beam 504b. First collimator lens 518a collimates diverging first radiation beam 504a to collimated first radiation beam 520a. Second collimator lens 518b collimates diverging second radiation beam 504b to collimated second radiation beam 520b. Each of the collimated radiation beams 520a, 520b is directed by a respective polarising beam-splitter 509a, 509b towards the objective lens 508. Each of the radiation beams 520a, 520b has a predetermined polarisation. The polarisation state of each beam is the same.

Objective lens 508 converges the first collimated radiation beam 520a to a spot 516a for scanning the first information layer 502a. Objective lens 508 converges the second radiation beam 520b to a second spot 516b, for scanning second information layer 502b. Second information layer 502b contains tracking information e.g. the second information layer 502b defines a series of grooves.

In this particular embodiment, the radiation beams 504a and 504b have different wavelengths. The objective lens is arranged to focus different wavelengths at different axial positions. Due to the difference in wavelength, the focal points of the radiation beams 520a, 520b formed by the objective lens 508 are at different axial positions along the optical axis 519.

A quarter wavelength plate 510 is placed on the optical axis 519 between the polarisation beam-splitters 509a, 509b, and the objective lens 508. The quarter wave plate 510 ensures that the radiation beams reflected from the respective information layers 502a, 502b are transmitted by the polarising beam-splitters 509a, 509b towards the information detector 523.

In this particular embodiment, all of the reflected radiation beams are focused upon a single information detector 523. Astigmatic servo lens 525 converges both of the reflected radiation beams 522a, 522b on the information detector 523. By placing a non periodic phase structure (NPS) in front of the servo lens 525, both reflected beams 522a, 522b, having different wavelengths, are focused on the information detector 523.

The intensity of each radiation beam is modulated. The radiation beams can be modulated by switching on and off the individual radiation sources, or by placing modulating gates or devices within the optical paths of each radiation beam 520a, 520b (or even the optical paths of the reflected radiation beams 522a, 522b).

By modulating the radiation beams, such that the information detector detects separately in turn the first radiation beam 522a, and then the second radiation beam 522b, the single information detector can determine information from each respective information layer 502a, 502b. Typically, the radiation beams will have to be modulated at a relatively high frequency, to achieve this effect.

For example, the modulation frequency (f_{mod}) can be chosen in the following way:

f_{mod}=n.f_{cut-off} wheren≧2

and f_{cut-off=(}2NA/lambda)*v.
(f_{cut-off} is the cut-off frequency of the Modulation Transfer Function (MTF) of the optical system.)
NA is the Numerical Aperture of the used objective lens, lambda is the wavelength (λ) of the relevant radiation beam (e.g. laser light), and v is the disc rotation speed (m/s) during readout.

The information detector 523 is a split detector, with four quadrants. Such an information detector can be utilised to detect focus information of the “slave” radiation beam incident on information layer 502a as well as focus information of the “master” radiation beam incident upon grooved information layer 502b.

As focus information of the radiation beam spot 516a can thus be determined, as well as focus information that the spot 516b incident upon information layer 502b, the information detector 523 can provide a combined focus error signal. Thus, focus actuator 512 can control objective lens system 508 to provide an optimum combined focus position for both radiation beams 520a, 520b.

Alternatively, separate focus actuators may be provided, for altering the focus position of each individual radiation beam. For example, this could be achieved by controlling the positions of the collimator lenses (lenses 518a, 518b in FIG. 5). Similarly, in device 300, the positions of collimator lenses 318a, 318b (or 320b) could be controlled, for controlling the focus position of each radiation beam.

It will be appreciated that the above embodiments are described by way of example only, and that various alternatives will be apparent to the skilled person as falling within the scope of the invention, based upon the teachings herein.

Whilst the embodiment shown in FIG. 5 utilises two separate radiation sources 507a, 507b to provide two radiation beams of different wavelength, it will be appreciated that a single radiation source can be utilised to provide two radiation beams of different wavelengths. For example, a single laser diode could be utilised, that emits at different wavelengths. In an optical scanning device incorporating such a laser source, only a single collimator lens is required. However, an additional NPS would typically be utilised in conjunction with the single collimator lens, in order to ensure that the radiation beams of both wavelengths are parallel (due to the chromatic dependence of the collimator lens).

For example, although only the embodiment device 500 illustrated in FIG. 5 is described as utilising a single information detector 523, it will be appreciated that other embodiments, utilising radiation beams of the same wavelength, may equally be implemented using a single information detector.

The radiation beams may have one wavelength or multiple wavelengths, with the radiation beams provided utilising separate or integrated radiation sources (e.g. lasers).

Although the embodiments have been described as being implemented utilising two information layers, it will be appreciated that other embodiments may be utilised using three or more information layers, with each information layer being scanned by a respective radiation beam. For example, an optical record carrier can comprise n layers, with one of the layers containing tracking information (e.g. being grooved), and the other (n−1) layers consisting of recordable information layers, that do not contain tracking information (e.g. being non-grooved).

In the above embodiments, only a single information layer (e.g. a grooved information layer) is described as providing tracking information. However, in alternative embodiments, two or more information layers provide tracking information, with at least an additional two information layers not containing tracking information. For example, an optical record carrier could comprise nₜ information layers containing tracking information (e.g. grooved layers). The optical record carrier would then comprise an additional nᵢ information layers that do not contain tracking information (where nᵢ is an integer multiple of nₜ). Each of the nₜ information layers is then utilised to provide tracking information for nᵢ/nₜ of the other information layers. The information layers containing tracking information may be equally spaced within the optical record carrier e.g. each tracking information layer separated by nᵢ/nₜ of the other information layers. This may be advantageous with respect to e.g. spherical aberration correction in an embodiment of an optical record carrier incorporating a large number of layers. Furthermore, it is possible to use a number of lasers n₁ that is smaller than the total number of layers nᵢ+nₜ, e.g. n₁=nᵢ+1. Although tracking information has been described as being provided within an information layer by a grooved structure, it will be appreciated that tracking information may be otherwise incorporated within the optical record carrier. For example, a regular ROM layer could be provided in the optical record carrier, with some information or program stored in the ROM layer. This ROM layer is then utilised to provide the radial tracking information e.g. by using a sampled servo tracking scheme, or a Differential Phase Detector (DPD) (see e.g. U.S. Pat. No. 4,497,048) tracking system. The information in subsequent multiple information layers is then being written to/read from utilising the tracking information provided by a radiation beam scanning the ROM layer. Again, these other information layers do not require any groove or particular alignment between the different information layers. In such a system, it is envisaged that two or more additional information layers are provided. A radiation beam is provided to scan each of the layers i.e. three radiation beams would be required to scan the two additional information layers and the ROM layer. The beams scanning the two additional information layers are arranged to utilise the tracking information from the beam reading the ROM layer.

The above embodiments are described as utilising astigmatic focus control. However, it will be appreciated that other focus control systems can be utilised e.g. the Foucault technique (also known as the Foucault knife technique), for providing focus control.

It is appreciated that real-world variations (e.g. due to differences in standards and/or manufacturing errors), may result in non-optimal conditions. For example, the distance between the information layers may vary between different optical record carriers. The distance between the information layers may vary slowly over the disc. Equally, the cover-layer thickness may vary between different discs and/or over the surface of each disc.

This variation in layer thickness will result in the “slave” radiation beams requiring a different focus error signal for correct focusing, compared to the “master” radiation beam utilised to scan the information layer containing the tracking information. The device 500 described with reference to FIG. 5 describes how the focus information of the “slave” (first) radiation beam 504a can be measured using the information detector 523. In the embodiment illustrated with respect to FIGS. 3 and 4A, focus information of the first radiation beam can be determined by utilising a split-photodetector as the information detector 323a, 423a of the first “slave” reflected radiation beam.

Alternatively, the focus information of the first radiation beam can be determined, by measuring the jitter (variation in the signal as a function of time e.g. variation in the signal with different marks on the information layer) in the read-out signal and by optimising the focus position based upon this jitter (to minimize the jitter).

The focal position of the first radiation beam can be varied using a number of techniques, such as by providing an actuator to alter the position of the collimator 318a, 518a of the first radiation beam along the optical path of the radiation beam.

In the embodiments illustrated in FIGS. 3 and 5, the scanning spots (316a, 316b; 516a, 516b) are described as being aligned, whilst the scanning spots (416a, 416b) are described with reference to FIGS. 4A and 4B have a predetermined tangential offset. It will be appreciated that the degree of alignment and/or tangential offset can alter due to manufacturing tolerances, or due to differences in different standards between different manufacturers. On a recorded disc, this can result in tracks that are still perfectly aligned in a predetermined relationship with respect to each other, but with a constant lateral offset between the tracks in different layers.

To overcome this potential difference in constant offset between tracks in different layers of different discs (e.g. caused by recording utilising different devices), devices may be provided that have a variable offset between the positions of the scanning spots. The collimator lens(es) may be provided with an actuator to alter the radial position of the lens relative to the optical path and/or the orientation of the lens relative to the optical path. It is thus possible to change the position of the “slave-spot” (i.e. first radiation beam spot 316a, 516a) relative to the position of the “master-spot” (i.e. second radiation spot 316b, 516b) in both tangential and radial directions.

When reading a disc that has already been recorded by another device, the actuator is used to alter the position and/or orientation of the collimator lens, to optimise the offset (or otherwise) between the radiation spots for that particular record carrier. By determining the jitter in the readout signal it is possible to optimise the radial position of the readout spot, by minimising the measured jitter of the read-out signal.

In this way, small differences in optical scanning devices can be compensated for. After the offset between the spots has been calibrated for the particular optical record carrier (e.g. with both radiation spots positioned on the respective information layer), the collimator lens can be fixed in position (in the radial direction). The optical record carrier can then be scanned using this determined offset between the two spots, as the offsets of the tracks on the disc has a fixed value.

By providing an optical record carrier in which only one information layer provides tracking information, there is a reduced manufacturing cost. No replication processes are required for each additional information layer of the multi-layer optical record carrier, as only one layer containing tracking information (e.g. one groove layer) needs to be replicated. Instead, only the relatively simple processing of spin-coating and sputtering are required to form the additional information layers.

After the optical record carrier has been fully recorded, the carrier can be backward compatible with conventional multi-layer optical record carrier systems, if desired. Further, the carrier can be quickly scanned, scanning all information layers on the carrier simultaneously.

1-20. (canceled)

21. An optical scanning device (300; 400; 500) for scanning a first (2a; 302a; 402a; 502a) and a second information layer (2b; 302b; 402b; 502b) of an optical record carrier (3; 303; 403; 503), the device comprising:
at least one radiation source (307a, 307b; 407; 507a, 507b) for providing a first radiation beam (15a; 304a, 320a, 315a; 404a; 504a, 520a, 522a) for scanning the first information layer and a second radiation beam (15b; 304b, 320b, 320b′, 315b; 404b; 504b, 520b, 522b) for scanning the second information layer;
an objective lens system (8; 308; 408; 508) for converging the first and second radiation beams on the respective information layers;
wherein the device is configured to determine tracking information from only one of said radiation beams, for tracking error compensation, the device further comprising at least one of:
means for writing information to the first information layer using the first radiation beam and writing information to the second information layer using the second radiation beam, and
means for detecting at least a portion of the first radiation beam reflected from the first information layer and at least a portion of the second radiation beam reflected from the second information layer, for determining information on said layers.

22. A device as claimed in claim 21, further comprising an actuator system for providing tracking error compensation for both the first and the second radiation beams, the actuator system being arranged to only utilize said tracking information from only one radiation beam.

23. A device as claimed in claim 21, wherein the objective lens system is configured to focus said first radiation beam and said second radiation beam at different axial positions along a common optical axis (19; 319; 519).

24. A device as claimed in claim 21, wherein the objective lens system (408) is arranged to focus the first radiation beam (404a) at a position along a first optical axis (419a), and the second radiation beam (404b) at a position along a second, different optical axis (419b).

25. A device as claimed in claim 24, wherein the optical record carrier (403) is an optical disc, with the second optical axis (419b) tangentially offset from the first optical axis (419a).

26. A device as claimed in claim 21, wherein the objective lens system (408) is arranged to converge the second radiation beam (404b) at a position a predetermined, fixed lateral distance from that of the first radiation beam (404a).

27. A device as claimed in claim 21, wherein the first radiation beam (504a, 522a) comprises a first wavelength, and the second radiation beam (504b, 522b) comprises a second, different wavelength.

28. A device as claimed in claim 27, further comprising a non-periodic phase structure (560) for converging both of said radiation beams (522a; 522b) on a common information detector.

29. A device as claimed in claim 21, wherein said first and said second radiation beams (504a, 522a; 504b, 522b) are modulated, for allowing information from both information layers to be detected by a common information detector.

30. A device as claimed in claim 21, wherein the device is arranged for scanning a third information layer of the optical record carrier; at least one radiation source is arranged to provide a third radiation beam for scanning the third information layer; and the objective lens system is arranged to converge the third radiation beam on the third information layer.

31. A device as claimed in claim 21, wherein the device is configured to determine focus information from only one of said radiation beams, for focus error compensation.

32. A method of manufacturing an optical scanning device for scanning a first and a second information layer of an optical record carrier, the method comprising:
providing at least one radiation source for providing a first radiation beam for scanning the first information layer and a second radiation beam for scanning the second information layer;
providing an objective lens system for converging the first and second radiation beams on the respective information layers; and
configuring the device to determine tracking information from only one of said radiation beams for tracking error compensation, the method further comprising providing at least one of:
means for writing information to the first information layer using the first radiation beam and writing information to the second information layer using the second radiation beam, and
means for detecting at least a portion of the first radiation beam reflected from the first information layer and at least a portion of the second radiation beam reflected from the second information layer, for determining information on said layers.

33. A method of scanning a first information layer and a second information layer of an optical record carrier, the method comprising:
converging a first radiation beam on the first information layer;
converging a second radiation beam on a second information layer; and
controlling the tracking of the radiation beams on the information layers, based upon a tracking information signal, wherein the tracking information signal is determined from only one of said beams, but utilised to provide tracking error compensation for both said first and said second radiation beams, the method further comprising at least one of:
writing information to the first information layer using the first radiation beam and writing information to the second information layer using the second radiation beam, and
detecting at least a portion of the first radiation beam reflected from the first information layer and at least a portion of the second radiation beam reflected from the second information layer, for determining information on said layers.

34. A method as claimed in claim 33, further comprising:
detecting the lateral distance between information stored on the first information layer and information stored on the second information layer, and
configuring the second radiation beam to scan the second information layer at the determined fixed lateral distance from the first radiation beam.
